(19) United States
(12) Patent Application Publication
(10) Pub. No.: US 2012/0069149 A1
(43) Pub. Date: Mar. 22, 2012

(54) PHOTOGRAPHING DEVICE AND CONTROLLING METHOD THEREOF, AND THREE-DIMENSIONAL INFORMATION MEASURING DEVICE

(75) Inventor: Tomonori Masuda, Saitama (JP)

(73) Assignee: FUJIFILM CORPORATION, Minato-ku, Tokyo (JP)

(21) Appl. No.: 13/143,461

(22) PCT Filed: Oct. 14, 2010
(86) PCT No.: PCT/JP2010/068037

§ 371 Date: Jul. 6, 2011

(30) Foreign Application Priority Data
Mar. 23, 2010 (JP) 2010-066034

(51) Int. Cl. H04N 13/02

(52) U.S. Cl. 348/46; 348/E13.074

(57) ABSTRACT

To make it easy to recognize that pixel resolving power is changed during photography operation.

A first camera and a second camera photograph two perspective images. A pixel resolving power calculation section 31 calculates pixel resolving power for photographing the two perspective images, based on a focal length, a base length, an object distance and a pixel size. In a reference pixel resolving power memorizing section 54, reference pixel resolving power is memorized. In a display section 25, the calculated pixel resolving power is displayed. A display control section 52 performs normal display of the pixel resolving power when the pixel resolving power is maintained to be no less than reference pixel resolving power, and performs highlighting display of the pixel resolving power when the pixel resolving power became a value lower than the reference pixel resolving power during photography operation.

### TECHNICAL FIELD

The present invention relates to a photographing device and a controlling method thereof, and a three-dimensional information measuring device to obtain three-dimensional information of a measurement object.

### BACKGROUND ART

As a photographing device to obtain three-dimensional information of a measurement object, for example a stereocamera is known. The stereocamera has a pair of cameras or image capturing units that are placed at right and left sides with a suitable distance between them, and photographs a parallax image of the measurement object as a measurement image. This parallax image includes a pair of right and left perspective images photographed with each camera. Based on the parallax of correspondence points on this pair of perspective images, three-dimensional information of the measurement object, that is, coordinates (Xi, Yi, Zi) of an arbitrary point Pi on the measurement object in the three-dimensional space is found.

Pixel resolving power of the above three-dimensional information, that is, a length (a plane (right and left or top and bottom) and a depth) on the three-dimensional space corresponding to a pixel interval on an image sensor is determined depending on each photographing condition of an object distance, a focal length of a taking lens, a pixel size, and an interval between the cameras (a base length). Therefore, it is necessary to set the object distance, the focal length and so on corresponding to an appropriate pixel resolving power for the measurement object.

Pixel resolving power at the set focal length is displayed in a photographing device acquiring three-dimensional information by light-section method. In this photographing device, when the displayed pixel resolving power does not make satisfaction, a user can input pixel resolving power to change the focal length of the taking lens to become this pixel resolving power (refer to Patent Document 1). In addition, a device for displaying pixel resolving power in a photographing condition that calibration data is applied when the calibration data that is for revising distortions and so on of the measurement image is generated, is also known (refer to Patent Document 2).

### PRIOR ART DOCUMENTS

### Patent Documents

Patent Document 1: Japanese Patent Laid-Open Publication No. 7-174538
Patent Document 2: Japanese Patent Laid-Open Publication No. 2003-242485

### SUMMARY OF INVENTION

### Problems to be Solved by the Invention

By the way, the pixel resolving power is an important factor in obtaining the three-dimensional information, and it is useful to display the pixel resolving power in photography of the measurement image. However, since the pixel resolving power is simply displayed on the conventional devices, there is a problem that photography is performed without noticing that pixel resolving power changed during photography operation.

The present invention intends to provide a photographing device and a controlling method thereof, and a three-dimensional information measuring device in which change of pixel resolving power can be recognized easily.

### Means for Solving the Problems

To achieve the intension mentioned above, a photographing device of the present invention comprises a measurement photography section, a condition obtaining section, a pixel resolving power calculation section, a display section, a reference pixel resolving power obtaining section and a display control section. The measurement photography section photographs a measurement image of a measurement object to obtain three-dimensional information. The condition obtaining section obtains a photographing condition for photographing the measurement image. The pixel resolving power calculation section calculates pixel resolving power of the measurement image based on the photographing condition. The display section displays the pixel resolving power that is calculated in the pixel resolving power calculation section. The reference pixel resolving power obtaining section obtains reference pixel resolving power for photographing the measurement image. The display control section changes a display mode of the display section when it is detected that the pixel resolving power becomes out of a reference range determined based on the reference pixel resolving power.

It is preferable that the display section displays a through image of the measurement image with the pixel resolving power. It is preferable that the reference pixel resolving power obtaining section obtains the pixel resolving power corresponding to the measurement image photographed at the last time as the reference pixel resolving power.

It is preferable to provide a recording section that records the pixel resolving power or the photographing condition with the measurement image when the measurement image is photographed, and a selecting section to select any measurement image from a plurality of the measurement images. The reference pixel resolving power obtaining section obtains pixel resolving power or photographing condition corresponding to the selected measurement image, and determines this pixel resolving power or pixel resolving power obtained from the photographing condition as the reference pixel resolving power.

It is preferable that the display section reproduces and displays the measurement image selected by the selecting section. A photographing condition range display section is provided to display a condition range of the photographing condition for making the pixel resolving power become in the reference range when the calculated pixel resolving power is out of the reference range. It is preferable that the photographing condition range display section displays a range out of the photographing condition range separately from the photographing condition range, in addition to the photographing condition range.

The measurement photography section has plural cameras to photograph each perspective image as the measurement image. The condition obtaining section obtains a focal length, an object distance, a pixel size, a base length that is a distance between the cameras, and so on as the photographing condition.

A projector section which projects measuring beam on the measurement object may be provided, and the measurement object being irradiated by the measuring beam may be photographed with one camera.

A three-dimensional information measuring device of the present invention comprises the photographing device and an analyzing section which calculates three-dimensional information based on the measurement image photographed by the photographing device.

A controlling method of a photographing device of the present invention comprises a calculation step for calculating pixel resolving power from photographing condition of the measurement image, a displaying step for displaying the pixel resolving power in a display section, an obtaining step for obtaining reference pixel resolving power in photographing the measurement image, a judgment step for judging whether the pixel resolving power becomes out of the reference range determined based on the reference pixel resolving power, and a changing step for changing display mode of the pixel resolving power on the display section when the pixel resolving power becomes out of the reference range.

In the displaying step, it is preferable that a through image of the measurement image is displayed with the pixel resolving power. In the obtaining step, it is preferable that pixel resolving power of the measurement image photographed at the last time is obtained as the reference pixel resolving power.

It is preferable to execute a recording step for recording the pixel resolving power or the photographing condition with the measurement image when the measurement image is photographed, and a selection step for selecting any measurement image from the plural measurement images. In the reference pixel resolving power obtaining step, the pixel resolving power or the photographing condition of the selected measurement image is obtained, and pixel resolving power obtained from this pixel resolving power or photographing condition is determined as the reference pixel resolving power. This selected measurement image is reproduced and displayed on the display section.

In addition, a step for setting at least one of the plural photographing conditions, and a range displaying step for displaying a condition range of the photographing condition for making the pixel resolving power become in the reference range when the pixel resolving power calculated in the calculation step is out of the reference range, are executed. It is preferable that in the range displaying step, a range out of the photographing condition range is displayed separately from the photographing condition range, in addition to the photographing condition range.

As the measurement image, plural perspective images from different viewpoints photographed with plural cameras are used. Or plural images which are made by photographing the measurement object scanned by slit-light are used.

### Effect of the Invention

According to the present invention, since the display mode is changed when the pixel resolving power is changed during the photography operation, it can be easily and surely recognized that the pixel resolving power is changed. In addition, since there is no need to judge whether the pixel resolving power changed, it can concentrate on determination of framing and so on.

### BRIEF DESCRIPTION OF DRAWINGS

FIG. 1 is a block diagram illustrating a constitution of a photographing device to which the present invention is applied.

FIG. 2 is a functional block diagram illustrating a function of a resolving power display control section.

FIG. 3A is an explanatory diagram illustrating a display example of pixel resolving power.

FIG. 3B is an explanatory diagram illustrating a state that display of the pixel resolving power is changed.

FIG. 4 is a flowchart illustrating a display control process of the pixel resolving power.

FIG. 5 is a functional block diagram illustrating a function of the resolving power display control section which detects a change of photographing condition and displays the pixel resolving power.

FIG. 6 is a flowchart illustrating a display control process in which the change of the photographing condition is detected and the pixel resolving power is displayed.

FIG. 7 is a functional block diagram illustrating a function of the resolving power display control section which detects changing operation of the photographing condition and displays the pixel resolving power.

FIG. 8 is a flowchart illustrating a display control process in which the changing operation of the photographing condition is detected and the pixel resolving power is displayed.

FIG. 9 is a functional block diagram illustrating a function of the resolving power display control section which obtains the reference pixel resolving power from an operating section.

FIG. 10 is a flowchart illustrating a display control process in which the reference pixel resolving power is obtained from the operating section.

FIG. 11 is a functional block diagram illustrating a function of the resolving power display control section which obtains pixel resolving power at the time of the last photography, as the reference pixel resolving power.

FIG. 12 is a functional block diagram illustrating a function of the resolving power display control section which obtains pixel resolving power at the time of photography of a parallax image which is selected to be reproduced, as the reference pixel resolving power.

FIG. 13 is an explanatory diagram illustrating contents of a file in which pixel resolving power at the time of the photography is recorded with the parallax image.

FIG. 14 is a functional block diagram illustrating a function of the resolving power display control section which displays a bar graph showing a range of the photographing condition satisfying the standard resolving power.

FIG. 15 is an explanatory diagram illustrating a display example of the bar graph showing the range of the photographing condition satisfying the standard resolving power.

FIG. 16 is a flowchart illustrating a display control process in which a bar graph is displayed during a constant period of time when the pixel resolving power is changed.

FIG. 17 is a flowchart illustrating a display control process in which a bar graph is displayed when a boundary value is out of a settable range.

FIG. 18 is a flowchart illustrating a display control process in which a bar graph is displayed when the pixel resolving power does not satisfy the reference pixel resolving power.

FIG. 19 is an explanatory diagram illustrating a display example of the bar graph when a range of the reference pixel resolving power is designated.

FIG. 20 is a block diagram illustrating a constitution of a photographing device which photographs a measurement image to obtain three-dimensional information in light-section method.

FIG. 21 is a block diagram illustrating a constitution of a three-dimensional information measuring device.

### MODE FOR CARRYING OUT THE INVENTION

### First Embodiment

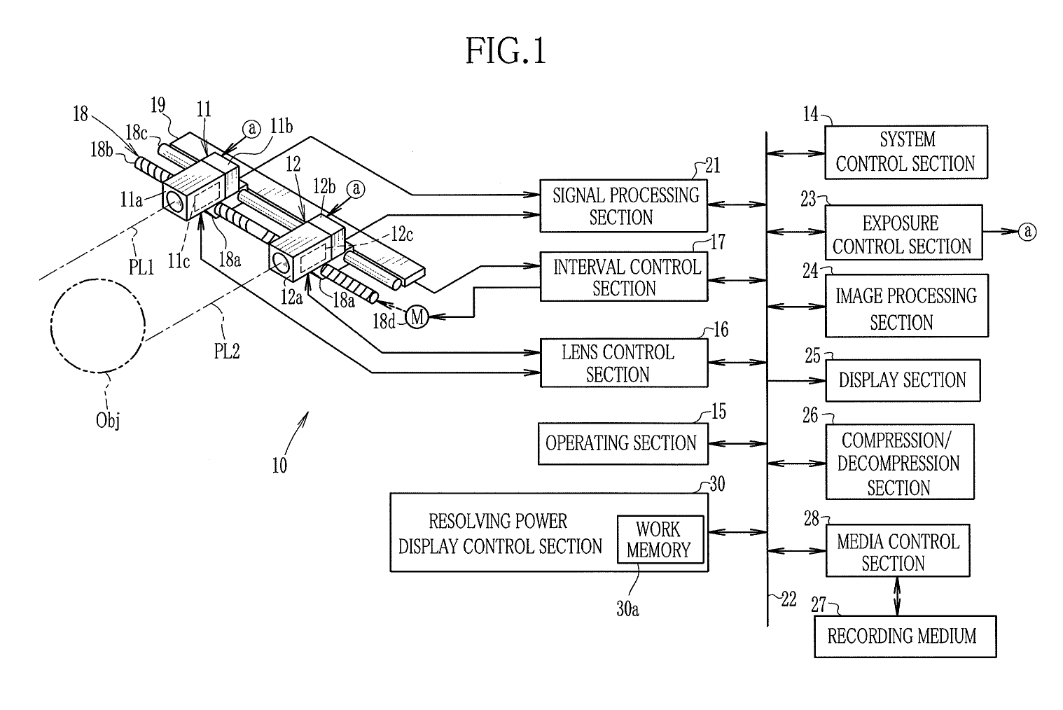

A photographing device of a first embodiment has a function to display a change when pixel resolving power is changed during photography operation. In FIG. 1, a photographing device 10 includes a first camera 11 and a second camera 12 as a measurement photography section. The first camera 11 and the second camera 12 photograph a parallax image as a measurement image so as to analyze and obtain three-dimensional information of a measurement object Obj, that is, coordinates (Xi, Yi, Zi) of an arbitrary point Pi in the measurement object in a three-dimensional space. The first camera 11 photographs a right perspective image of the measurement object Obj. The second camera 12 photographs a left perspective image of the measurement object Obj. The parallax image is a set of the right perspective image and the left perspective image.

A system control section 14 integrally controls each part of the photographing device 10. An operating section 15 has an operation button and can perform setting of photographing condition, instructions of photography of a parallax image, and so on. As the photographing condition, there are a focal length of each camera 11, 12, an interval between the cameras 11, 12, that is, a base length, a pixel size of each perspective image, and an object distance to the measurement object Obj. In these photographing conditions, the focal length, the base length and the pixel size can be set through the operating section 15. The object distance is determined by a position of the measurement object Obj against each camera 11, 12.

The first camera 11 and the second camera 12 are located along a direction where optical axes PL1, PL2 become parallel each other with a constant distance between them. The direction where the first camera 11 and the second camera 12 are arranged is not limited to the longitudinal direction, and for example it may be the vertical direction. In addition, although two perspective images are respectively photographed from two viewpoints with the two cameras 11, 12 in this example, perspective images from more than three viewpoints may be photographed with more than three cameras, or perspective images from more than three viewpoints may be photographed by moving one camera.

The first camera 11 is composed of a taking lens 11a and an image sensor section 11b, and an optical image focused through the taking lens 11a is converted into an electric signal by the image sensor section 11b and is output. The image sensor section 11b is composed, for example, of a CCD type or MOS type image sensor. The taking lens 11a is of zoom type that can change a focal length between the wide end and the telephoto end, and can adjust the focal length through zooming operation. The second camera 12, which has the constitution same as the first camera 11, is composed of a taking lens 12a of zoom type and an image sensor section 12b.

According to operation of the operating section 15, a lens control section 16 controls each taking lens 11a, 12a to be the same focal length. In addition, based on image data from a signal processing section 21 described later, the lens control section 16 adjusts focus of each taking lens 11a and 12a so that the focus meets the measurement object Obj, for example by contrast detection method. Note that the focus adjustment may be done by triangulation method or so on.

Each taking lens 11a, 12a have each built-in encoder unit 11c, 12c that detects a position of a built-in zoom lens and a position of a focus lens. Based on an encoding signal from the each encoder unit 11c, 12c, the lens control section 16 detects the focal length of the each taking lens 11a, 12a, and detects a distance to the object on which the focus of the each taking lens 11a, 12a meets, as the object distance. The each encoder unit 11c, 12c and the lens control section 16a constitute a condition obtaining section for obtaining the focal length and the object distance.

The techniques for obtaining the focal length and the object distance are not limited to above. About the object distance, for example a range-finding sensor for measuring the object distance may be separately provided, or the object distance may be calculated from parallax of correspondence points of perspective images photographed with the cameras 11 and 12. In addition, the object distance may be designated through the operating section 15 and the taking lenses 11a and 12a may be controlled so that their focuses meet the designated distance. In this case, the designated object distance is obtained as the photographing condition. Of course it is necessary to place the measurement object Obj at the designated object distance.

Furthermore, a shifting mechanism to shift the measurement object Obj relative to the each camera 11, 12 may be provided so that a distance between the measurement object Obj and the each camera 11, 12 increases and decreases. In this case, a measurement sensor may be provided in the shifting mechanism to obtain the object distance. In addition, for example in case the shifting mechanism is driven to become the object distance input through the operating section 15, the object distance input through the operating section 15 is obtained as the photographing condition.

The first and the second cameras 11, 12 are attached to an interval adjusting mechanism 18 which is controlled by an interval control section 17. The interval control section 17 drives the interval adjusting mechanism 18 according to operation of the operating section 15 to increase and decrease an interval between the first and the second cameras 11, 12. Accordingly, the base length is changed.

The interval adjusting mechanism 18 is comprised of a pair of shifting members 18a, a lead screw 18b, a guide axis 18c, a motor 18d and so on. The lead screw 18b and the guide axis 18c horizontally extend in the longitudinal direction and are arranged to be parallel to each other. The first camera 11 is attached to one of the shifting members 18a, and the second camera 12 is attached to the other of the shifting members 18a, respectively. In addition, the each shifting member 18a is movable along the longitudinal direction, because the lead screw 18b is inserted in a screw aperture of the shifting member 18a, and the guide axis 18c is inserted in a groove of the shifting member 18a.

On the lead screw 18b, a right-handed screw is formed along one end side, and a left-handed screw is formed along the other end side, both from the center. The lead screw 18b is rotated by the motor 18d whose drive is controlled by the interval control section 17. When the motor 18d rotates in the normal direction to rotate the lead screw 18b in one direction, the each shifting members 18a moves in each direction to reduce the distance between them. When the motor 18d rotates in the counter direction to rotate the lead screw 18b in the other direction, the each shifting members 18a moves in each direction to increase the distance between them.

To the interval adjusting mechanism 18 mentioned above, an encoder 19 that detects a shift position of the each shifting member 18a is attached. The interval control section 17 obtains the base length based on an encoder signal, which represents the shift position of the each shifting member 18a, from the encoder 19. Note that the technique for obtaining the base length is not limited to this, and for example, there may be a constitution to obtain the base length based on the drive pulse number supplied to the motor 18d.

The signal processing section 21 is composed of a correlation double sampling circuit, an amplifier circuit, an A/D converter which are provided corresponding to the each camera 11, 12. The signal processing section 21 applies noise reduction and signal amplification to an output signal from the each camera 11, 12, and then applies a digital conversion and outputs obtained image data to a bus 22.

Sections such as the system control section 14, the lens control section 16, the interval control section 17, the signal processing section 21 are connected to the bus 22, and each section can exchange data and various instructions through the bus 22.

An exposure control section 23 controls an electronic shutter speed to make a correct exposure in response to photography instructions through operation of the operating section 15 for activating the each camera 11, 12 to photograph a perspective image. An image processing section 24 performs white balance correction, gamma correction and so on against the two perspective images.

The image sensor sections 11b, 12b apply a photoelectric conversion to a subject image and output it, by reading electric charge accumulated to each pixel of the image sensor, as is generally known. In reading the electric charge, the exposure control section 23 performs resolution conversion for example by pixel mixture, depending on a resolution mode appointed through operation of the operating section 15. A basic pixel size is determined by the pixel size of the image sensor, but the pixel size is changed by the resolution conversion such as the pixel mixture. The exposure control section 23 obtains the pixel size that is one of the photographing conditions, and outputs the pixel size corresponding to the resolution conversion. Note that in case the resolution of the each perspective image is changed by image processing, a pixel size corresponding to the resolution changed by the image processing may be obtained. In addition, the resolution can be changed by pixel skipping instead of the pixel mixture, and, on the contrary, may raise the resolution by pixel interpolation or the like.

A display section 25 is composed of a VRAM for memorizing image data of an image which should be displayed, a driver for generating a driving signal based on the image data memorized in the VRAM, a monitor which is driven by the driving signal from the driver, and so on. During the photography mode, the right perspective image photographed in one camera, for example the first camera 11, is input into the display section 25 sequentially and is displayed as a through image. The operator can observe the through image and perform framing. In addition, under the reproduction mode, the each photographed perspective image is displayed.

In addition, the display section 25 displays the pixel resolving power. Under the photography mode, the pixel resolving power of the three-dimensional information carried out from the photographed parallax image is displayed. The pixel resolving power is the length corresponding to the size of the pixel on the image sensor, and there are a pixel resolving power of the distance on the plane which is perpendicular to optical axes PL1, PL2 (hereinafter referred to as the plane pixel resolving power), and a pixel resolving power in a depth direction which is parallel to the axes PL1, PL2 (hereinafter referred to as the depth pixel resolving power).

A compression/decompression section 26 compresses data of a parallax image in a predetermined format when the parallax image is recorded in a recording medium 27, and decompresses the parallax image read out from the recording medium 27. The decompressed parallax image is sent to the display section 25.

A media control section 28 performs writing data to and reading data from the recording medium 27. Two perspective images photographed in the photography mode are recorded as one file in the recording medium 27.

In addition, in the reproduction mode, the media control section 28 reads the file from the recording medium 27, applies the decompression process to the two perspective images in the file in the compression/decompression section 26, and then sends the images to the display section 25. Accordingly, the parallax image recorded in the recording medium 27 is reproduced on the display section 25 so as to be able to be viewed stereoscopically.

A resolving power display control section 30 controls display mode of a pixel resolving power displayed on the display section 25. The resolving power display control section 30 has a work memory 30a to temporary memorize a calculated pixel resolving power and so on.

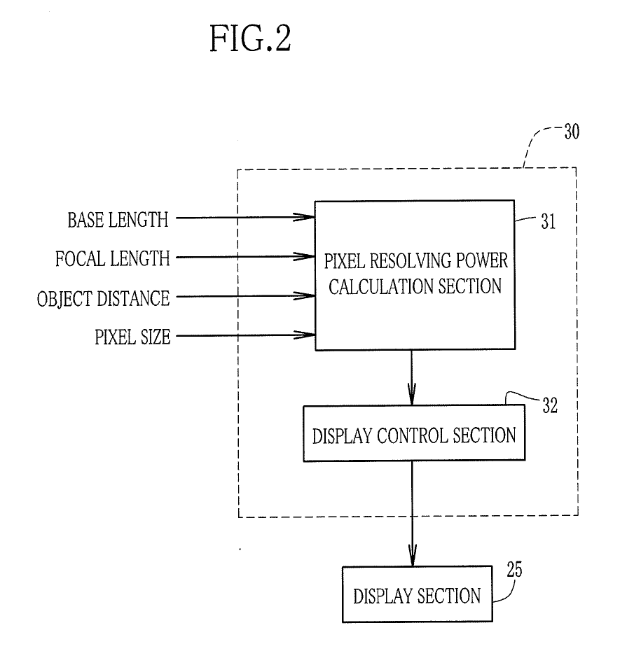

In FIG. 2, a pixel resolving power calculation section 31 calculates the pixel resolving power based on the base length that is the photographing condition, the focal length, the object distance, and the pixel size, which are input therein. As described above, the base length is obtained by the interval control section 17, the focal length and the object distance are obtained by the lens control section 16, and the pixel size is obtained by the exposure control section 23, respectively. In addition, the calculation of the pixel resolving power is performed for example every period of time.

The plane pixel resolving power ΔXY and the depth pixel resolving power ΔZ can be calculated by following formulae 1 and 2.

ΔXY=H·p/f [Formula 1]

ΔZ=H²·p/(f·d) [Formula 2]

Wherein d represents the base length, and f represents the focal length, H represents the object distance, and p represents the pixel size.

A display control section 32 detects change of the pixel resolving power calculated in the pixel resolving power calculation section 31. When the change is detected, a display mode of the pixel resolving power on the display section 25 changes. Whenever the pixel resolving power is calculated in the pixel resolving power calculation section 31, the display control section 32 compares the pixel resolving power calculated at this time with the pixel resolving power calculated at the last time, between the corresponding ones. That is, the plane pixel resolving power calculated at this time is compared with the plane pixel resolving power calculated at the last time, and the depth pixel resolving power calculated at this time is compared with the depth pixel resolving power calculated at the last time.

In the above comparison, when the pixel resolving power calculated at this time and the pixel resolving power calculated at the last time are different with each other, the display control section 32 judges that pixel resolving power is changed and changes display of the pixel resolving power on the display section25 from a normal display to a highlighting display. The highlighting display is continued in constant duration time Tref. When the pixel resolving power does not change, the normal display is maintained.

Note that the pixel resolving power calculated at the last time is memorized for example in the work memory 30a, and the pixel resolving power memorized in this work memory 30a is updated by the pixel resolving power calculated at this time whenever a comparison is completed. Note that it may update the pixel resolving power memorized in the work memory 30a only when the pixel resolving power changes.

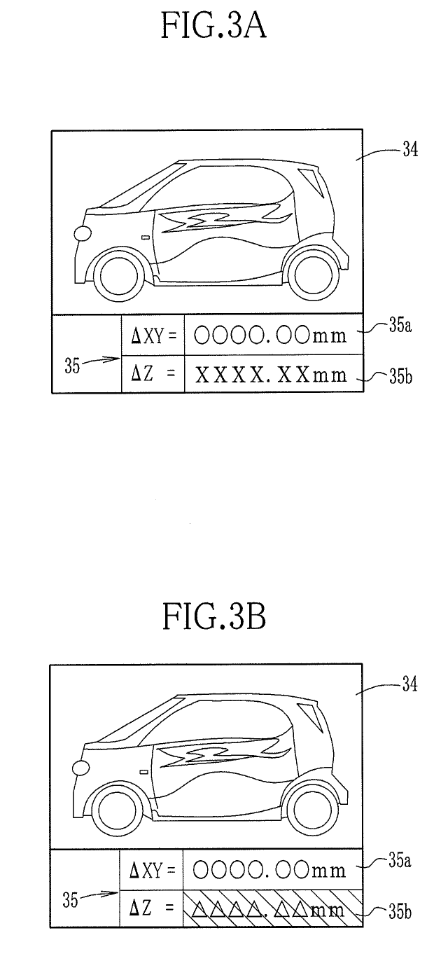

An example of a state of the display section 25 is illustrated in FIG. 3. A display screen of the display section 25 is provided with a through image display area 34, and a pixel resolving power display area 35 to display the pixel resolving power. Through observing a through image in the through image display area 34, a framing can be determined. The pixel resolving power display area 35 is divided into a plane pixel resolving power display area 35a and a depth pixel resolving power display area 35b.

In the normal display corresponding to the state that the pixel resolving power does not change, each pixel resolving power is displayed for example by black letters black on white background on the each pixel resolving power display area 35a, 35b, as illustrated in FIG. 3A. On the other hand, in the highlighting display corresponding to the state that the pixel resolving power changes, the pixel resolving power is displayed for example by white letters on the red background, as illustrated in the depth pixel resolving power display area 35b of FIG. 3B. In this way, the pixel resolving power is displayed with emphasis on the display screen, so that the operator is informed that the pixel resolving power changes during photography operation.

Next, an operation of the above embodiment will be described. For photographing the measurement object Obj, at first the measurement object Obj is put before the cameras 11, 12. When the photographing device 10 is activated, photography of video image is started by the first camera 11, and the photographed image is sent to the display section 25 through the signal processing section21 and the image processing section 24, to be displayed as a through image.

In addition, it can observe the through image in the state that focus meets the measurement object Obj, since focus adjustment of the taking lenses 11a, 12a is performed by the lens control section 16 based on the image data from the signal processing section 21. Note that the focus adjustment may be performed in response to instructions of the focus adjustment by the operating section15, half push operation of a release button and so on.

The through image is displayed on the display section 25 as described above, and each pixel resolving power is displayed on the pixel resolving power display area 35 which is provided on a lower part of the display section 25. At this time, in case there is no adjustment of the focal length of the each taking lens 11a, 12a, the object distance and the base length, and there is no change of the resolution, the each pixel resolving power displayed on the pixel resolving power display area 35 is maintained in the state of the normal display, as illustrated in FIG. 3A.

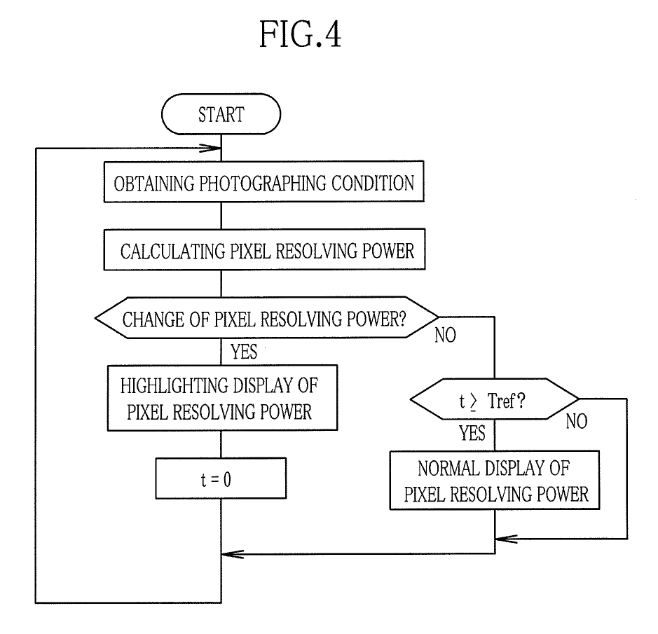

By the way, while the display of the through image is performed as described above, the display of the pixel resolving power is controlled by activating the resolving power display control section 30 to perform the display control process every period of time. As illustrated in FIG. 4, at first, based on an encoding signal from one camera such as the first camera 11, the focal length and the object distance of the each taking lens 11a, 12a are obtained by the lens control section 16. In addition, the base length is obtained by the interval control section 17 based on an encoding signal from the encoder 19, and a pixel size according to a designated resolution is obtained by the exposure control section 23.

The photographing conditions obtained by these sections as described above are sent to the resolving power display control section 30, and based on these, the pixel resolving power is calculated. When the pixel resolving power is calculated, the each pixel resolving power calculated at this time is compared with the each pixel resolving power calculated at the last time between the corresponding ones, so as to check whether there is a change of the pixel resolving power or not.

When the pixel resolving power is different with the other according to the above comparison, the highlighting display is applied for the mismatched pixel resolving power. For example, the highlighting display is applied only for the depth pixel resolving power when only the depth pixel resolving power is different with the other. When both the plane pixel resolving power and the depth pixel resolving power are different with the others, the each pixel resolving power is subject to the highlighting display. After that, timing is started after resetting a timer count for controlling highlighting display time, and the display control processing is finished. Note that the timer count is reset whenever the pixel resolving power becomes mismatched.

On the other hand, it is examined whether the timer count reaches the duration time Tref, when the pixel resolving power matches with the other. Then this processing is finished when it does not reach, and when it reaches, this display control processing is finished after returning the highlighting display to the normal display if there is the pixel resolving power being subject to the highlighting display. Note that it may perform the control of the timing to return the highlighting display to the normal display separately for the depth pixel resolving power and the plane pixel resolving power.

The operator operates the operating section 15 while observing a through image displayed on the display section 25, so as to regulate the focal length and the object distance of the each taking lens 11a, 12a as needed, to adjust the base length, and to designate the resolution.

For example, when the operating section 15 is operated to instruct a change of the focal length, zooming of the each taking lens 11a, 12a is carried out by the lens control section 16 so as to change the focal length. In addition, when a change of the camera interval (the base length) is instructed through the operating section 15, the lead screw is turned by the motor 18d in a direction according to the instruction, accordingly the camera interval is changed since the first camera 11 and the second camera 12 shift in the direction to be close to each other or in the direction to be apart from each other.

The measurement object Obj is moved to be close to or apart from the each camera 11, 12. Or the photographing device 10 is moved to be close to or apart from the measurement object Obj. When the interval (object distance) between the measurement object Obj and the each camera 11, 12 is changed in this way, the focus of the each taking lens 11a, 12a is adjusted to follow the change.

Furthermore, when a resolution is designated, the image sensor sections 11b, 12b are controlled to be subject to pixel mixture or not, so as to become the designated resolution. Note that the change of the resolution may perform when the parallax image is photographed. Therefore, while displaying the through image, reading of electric charge can be performed to be suitable for the video image, without performing the pixel mixture.

As described above, when it is performed that the adjustment of the focal length, the object distance and the base length, and the change of the resolution, the pixel resolving power changes according to these changes. Accordingly, when the change is detected through the display control process, the changed pixel resolving power is subject to the highlighting display.

Therefore, for example when only the depth pixel resolving power changes, as illustrated in FIG. 3B, the depth pixel resolving power is displayed by the white letters on the red background in the depth pixel resolving power display area 35b, so as to inform that there is the change of this pixel resolving power. In addition, when the plane pixel resolving power changes in the same way, the plane pixel resolving power is displayed by the white letters on the red background in the plane pixel resolving power display area 35a.

And since the highlighting display is continued by resetting the timer count whenever the photographing condition is changed and it is detected that the pixel resolving power changes, the highlighting display of the pixel resolving power changed accordingly is continued while the photographing condition is changed. When the pixel resolving power stops changing, the pixel resolving power in the highlighting display becomes subject to the normal display, after the duration time Tref is passed since the time that the last change of the pixel resolving power is detected.

Since the display mode of the pixel resolving power is changed as described above, the operator should pay attention to the pixel resolving power only when the highlighting display is performed and the change of the pixel resolving power is informed, and usually may concentrate on decision of the framing and so on.

After decision of the photographing condition and the framing, instruction of photography is performed through operation of the operating section 15. By the instruction of photography, photography of still image is carried out by each of the first and second cameras 11, 12. In this way, the parallax image, consisting of the right perspective image and the left perspective image that are photographs of an objected part of the measurement object Obj, is photographed. And the two perspective images are sent to the compression/decompression section 26 for the data compression, then sent to the media control section 28 and recorded as one file in the recording medium 27.

In the first embodiment described above, although the normal display is switched to the highlighting display when there is a change of the pixel resolving power, change of the display mode is not limited to this, and for example a text size, a text color, and a display position for displaying the pixel resolving power may be changed. In case the change of the text size, the text size becomes larger than that in the normal display. In case the change of the text color, the text becomes a color louder than that in the normal display. In case the change of the display position, the text is displayed at a position more noticeable than that in the normal display. In addition, the text for displaying the pixel resolving power may flash when there is a change of the pixel resolving power, or it may be that the normal display is undisplayed and the pixel resolving power is displayed only when there is a change of the pixel resolving power.

### Second Embodiment

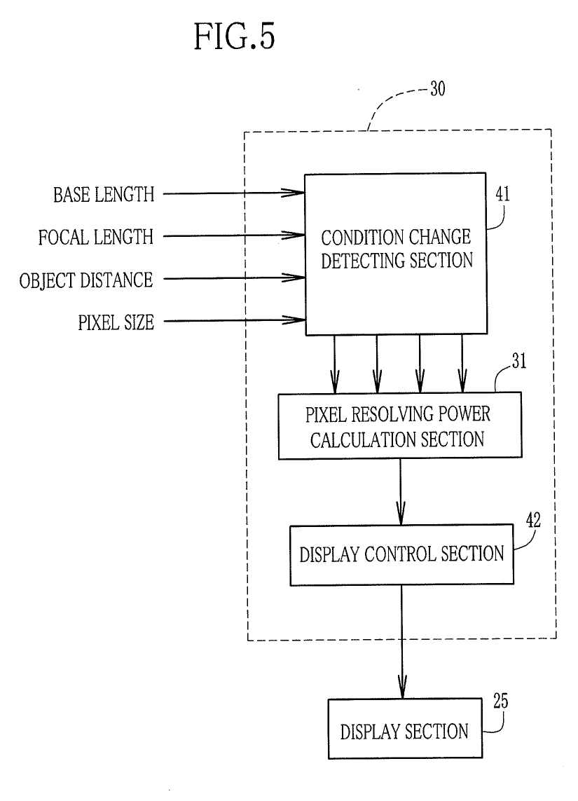

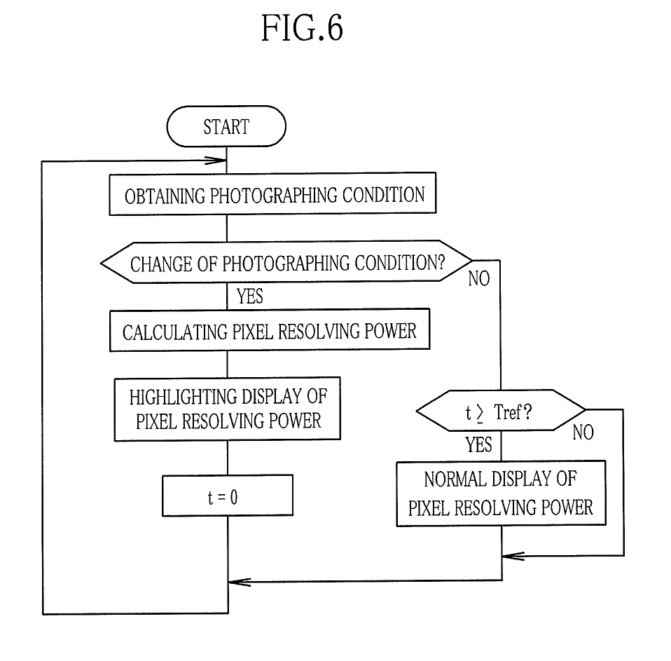

FIG. 5 and FIG. 6 illustrate a second embodiment in which a change of the photographing condition is detected and a display mode of the pixel resolving power is changed. Note that since it is similar to the first embodiment except for matters to be described below, it refers the same reference number to the substantially same component and omits the detailed description. In FIG. 5, the resolving power display control section 30 is composed of a condition change detecting section 41, the pixel resolving power calculation section 31, and a display control section 42. Other components are the same as the first embodiment.

As illustrated in FIG. 6, the condition change detecting section 41 detects a change of the photographing condition obtained by each section. When it is detected by the condition change detecting section 41 that at least one of input photographing conditions is changed, each photographing condition is sent to the pixel resolving power calculation section 31, and the pixel resolving power is calculated. When the each pixel resolving power is calculated, the display control section 42 displays the calculated pixel resolving power on the display section 25, and the display of the pixel resolving power is changed to the highlighting display during the duration time Tref.

Note that when only the object distance is changed, since only the depth pixel resolving power is changed, it is preferable that only the display of the depth pixel resolving power is subject to the highlighting display in this case. The detection of the change of the object distance may be performed by detecting a movement of the measurement object Obj itself or detecting a movement of the photographing device 10, in addition by comparing the object distance s.

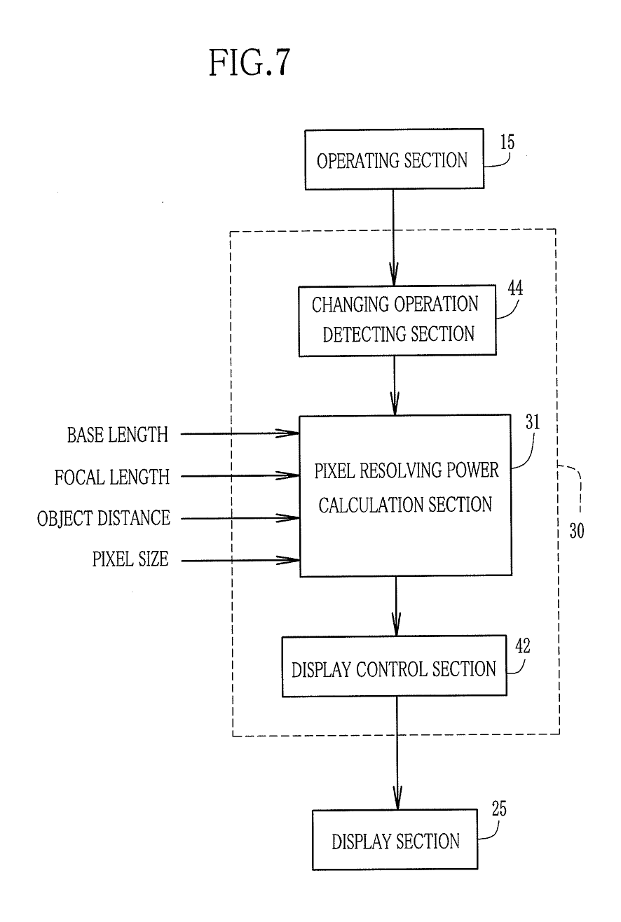

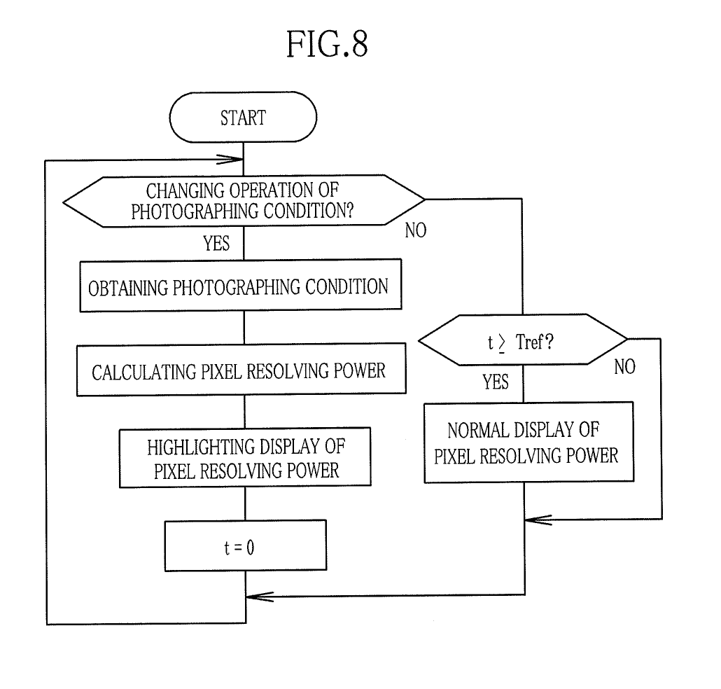

Although the change of the photographing condition itself is detected in this embodiment, the change of the photographing condition may be detected by detecting an operation to change the photographing condition, as illustrated in FIG. 7 and FIG. 8. In this example, a changing operation detecting section 44 detects the operation to change the photographing condition. When an operation to change either one of the photographing conditions is detected by the changing operation detecting section 44, calculation of the pixel resolving power is instructed to the pixel resolving power calculation section 31, and the pixel resolving power is calculated from the photographing condition. The display control section 42 displays the each calculated pixel resolving power on the display section 25, and the display of it is changed to the highlighting display during the duration time Tref.

Note that when the object distance is not changed by operation of the photographing device 10, it is preferable that a change of the photographing condition is detected such as the example illustrated in FIG. 5 and FIG. 6, than the constitution to detect the changing operation. And in this case, it is preferable that a value corresponding to a real object distance is obtained at least every display control processing.

### Third Embodiment

A third embodiment, in which a display mode of the pixel resolving power is controlled based on a reference range, will be described. Note that since it is similar to the first embodiment except for matters to be described below, it refers the same reference number to the substantially same component and omits the detailed description.

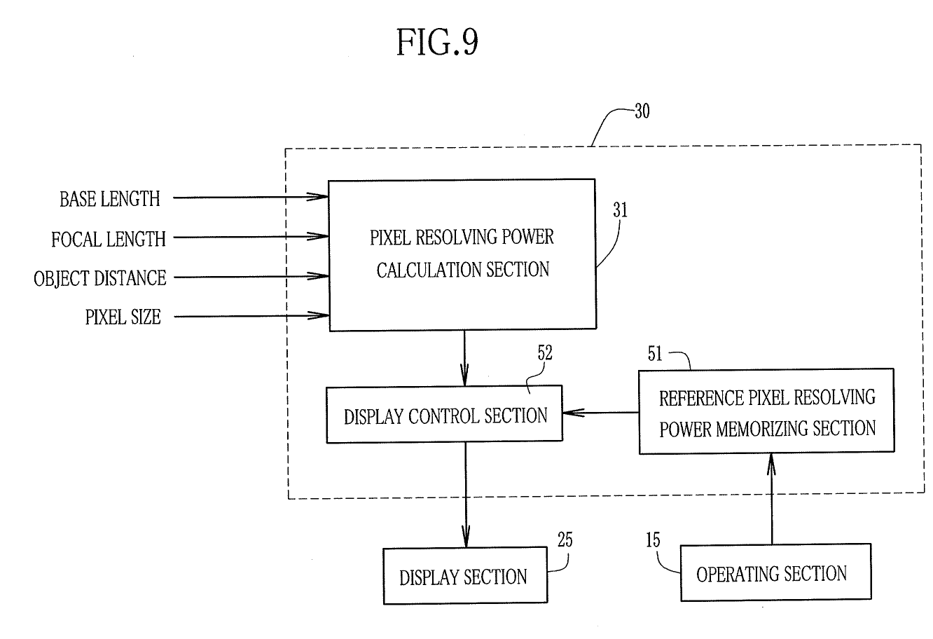

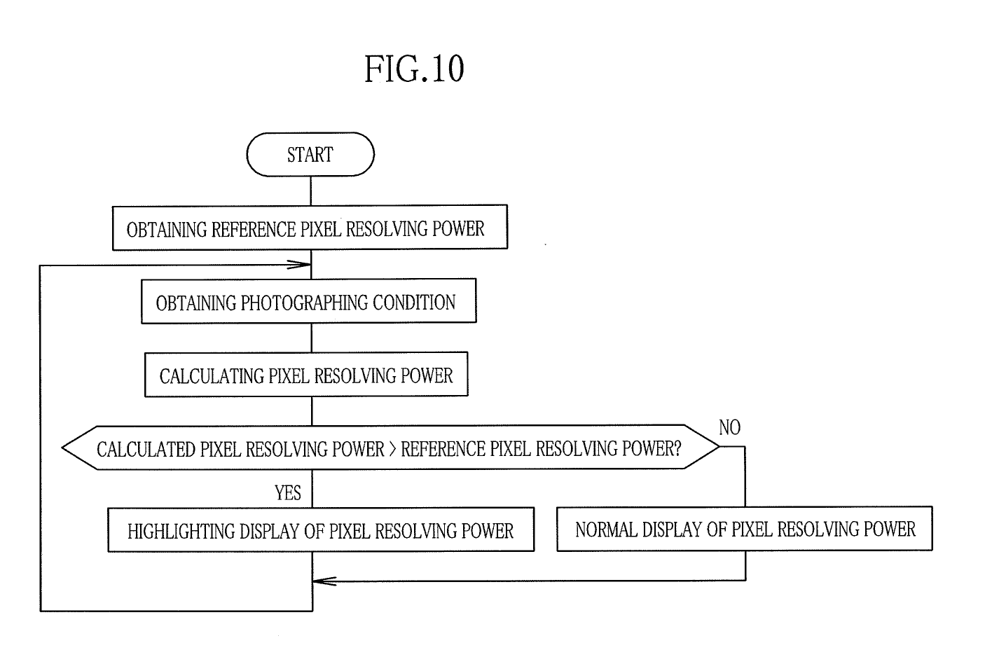

Function blocks of the resolving power display control section 30 in this example are illustrated in FIG. 9, and display control processes are illustrated in FIG. 10. A reference pixel resolving power memorizing section 51 is composed of for example a work memory 30a and memorizes the obtained reference pixel resolving power. In this example, the operating section 15 obtains the reference pixel resolving power, that is, the reference pixel resolving power is input through operation of the operating section 15 to be memorized in the reference pixel resolving power memorizing section 51. The reference pixel resolving power is the pixel resolving power to be required according to a purpose in use of the measurement result and so on for obtaining the three-dimensional information, and the plane pixel resolving power and the depth pixel resolving power are memorized.

A display control section 52 decides a range of the pixel resolving power to be the reference for judgment (hereinafter referred to as the reference range), based on the obtained reference pixel resolving power (the required pixel resolving power to obtain optimum three-dimensional information). In addition, the display control section 52 changes the display mode of the pixel resolving power when it is detected that the pixel resolving power calculated in the pixel resolving power calculation section 31 became out of the reference range. In this example, since the obtained reference pixel resolving power is set to be the upper limit of the reference range, the normal display is switched to the highlighting display when the calculated pixel resolving power becomes lower (larger) than the reference pixel resolving power.

After obtaining the reference pixel resolving power, the pixel resolving power is calculated by the pixel resolving power calculation section 31, from the each photographing condition. The calculated pixel resolving power and the upper limit of the reference range (the reference pixel resolving power) are compared with each other between the corresponding ones, by the display control section 52. The highlighting display is applied to the each pixel resolving power when the latter is bigger (the pixel resolving power is lower) than the former, and the normal display is applied when the latter is as same as or smaller (the pixel resolving power is higher) than the former. As a result, the highlighting display is applied only when the pixel resolving power is not in the required range.

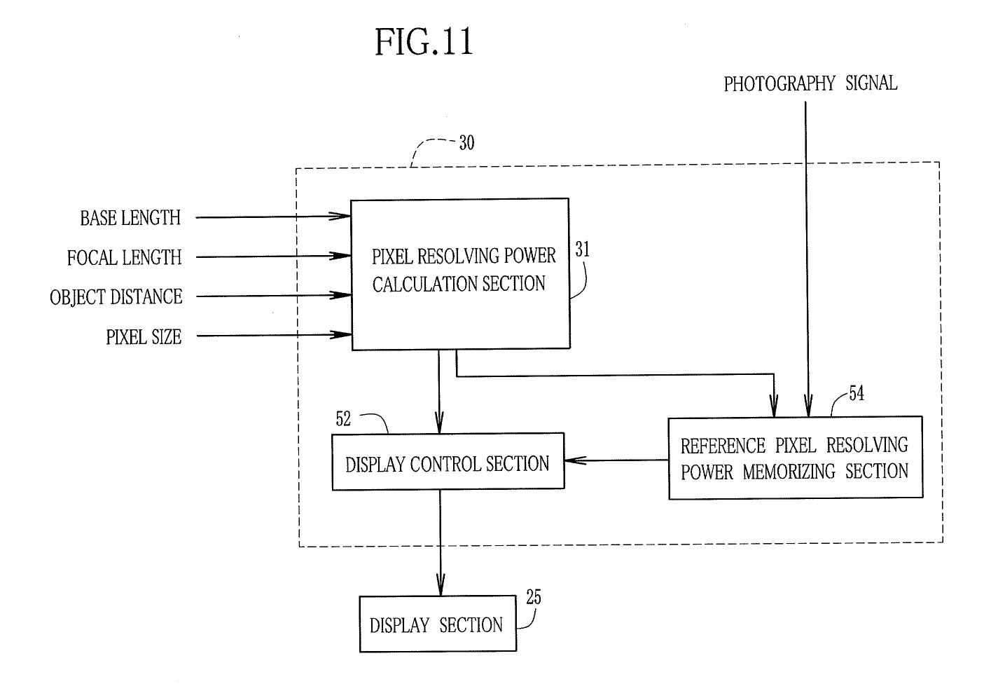

The obtaining method of the reference pixel resolving power is not limited to above. In an example illustrated in FIG. 11, pixel resolving power at the time when the parallax image is photographed at the last time is obtained as the reference pixel resolving power. Each pixel resolving power calculated in the pixel resolving power calculation section 31 is input into a reference pixel resolving power memorizing section 54. In addition, a photography signal that is generated when a parallax image is photographed, as the instruction to acquire the pixel resolving power, is input into the reference pixel resolving power memorizing section 54. When the photography signal is input, the reference pixel resolving power memorizing section 54 obtains and memorizes the each pixel resolving power calculated at that time as the reference pixel resolving power.

As same as the example of FIG. 9 and FIG. 10, the reference pixel resolving power memorized in the reference pixel resolving power memorizing section 54 is determined as the upper limit of the reference range. The display control section 52 examines whether the pixel resolving power calculated in the pixel resolving power calculation section 31 is out of the reference range or not, and controls the display mode of the pixel resolving power based on the result. Accordingly, it is convenient for example when photographing is performed with the pixel resolving power as same as or higher than that in the photography of the parallax image at the last time.

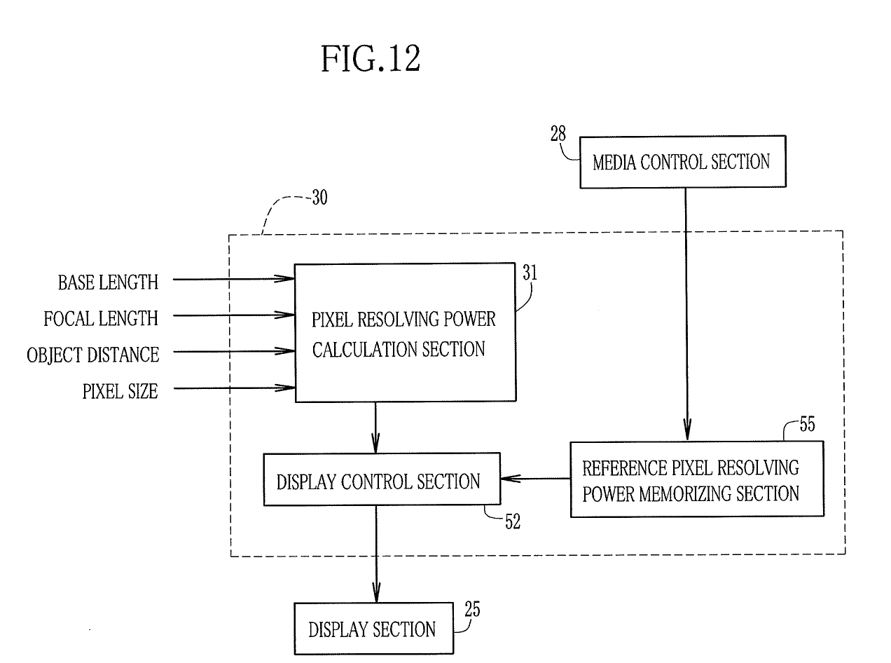

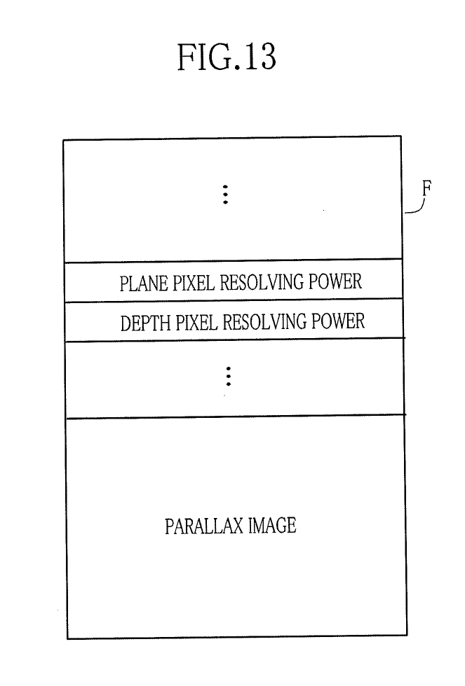

In addition, in an example illustrated in FIG. 12 or the like, the pixel resolving power of a reproduced parallax image may be determined as the reference pixel resolving power. In this example, the media control section 28 functions as the reference pixel resolving power obtaining section. As illustrated in FIG. 13, for recording a parallax image (two perspective images) as a file, tags containing the plane pixel resolving power and the depth pixel resolving power when the parallax image is photographed are recorded in a file F, with data of the parallax image, by the media control section 28.

Under the reproduction mode, the media control section 28 reads a file selected through the operating section 15, and then sends two perspective images included in the file to the display section 25 through the compression/decompression section 26, so as to displays them as an image for stereoscopic vision. In addition to this, the pixel resolving power is read from the tag, and is send to a reference pixel resolving power memorizing section 55 to be memorized. The memorized content of the reference pixel resolving power memorizing section 55 is updated, whenever a file is read out, to pixel resolving power recorded in a tag of the read file.

When it is switched to the photography mode from the reproduction mode, the display control section 52 examines whether the pixel resolving power calculated in the pixel resolving power calculation section 31 is out of the reference range or not, and controls the display mode of the pixel resolving power based on the result, under the condition that the reference pixel resolving power memorized in the reference pixel resolving power memorizing section 55 at that time is determined as the upper limit of the reference range. Accordingly, it is convenient for photographing the parallax image with the pixel resolving power as same as or higher than that in the parallax image photographed before.

Note that in this example, by recording the plane pixel resolving power and the depth pixel resolving power to the tag of the file including the parallax image, the parallax image and the pixel resolving power are recorded in relation with each other. In addition, the parallax image and the pixel resolving power may be recorded as the respective files, and the name of the other file in relation with the tag included in these files may be recorded, or a file to connect the both files may be recorded.

In addition, the photographing condition may be recorded instead of the pixel resolving power, so that the resolving power can be calculated from the photographing condition. The parallax image and the pixel resolving power may be recorded in a memory or a hard disk in substitution for the recording medium 27. Furthermore, it may constitute to read the data of the recorded pixel resolving power regardless of the parallax image.

In the each example illustrated in the third embodiment described above, the obtained reference pixel resolving power is set to be the upper limit of the reference range, and whether the calculated pixel resolving power is larger than the upper limit or not is judged. However, utilization of the reference range that is determined from the obtained reference pixel resolving power may be set optionally. For example, it may be that each of the upper limit and the lower limit of the reference range is determined from the reference pixel resolving power and whether it is in the reference range or not is judged. In addition, it may be that only the lower limit of the reference range is determined from the reference pixel resolving power and whether the calculated pixel resolving power is smaller than the lower limit or not is judged. In addition, the upper limit and the lower limit may be the same value, such as a reference pixel value, and the display of the pixel resolving power may be changed to the highlighting display when it deviated from the value of this pixel resolving power.

It may preset ratios of the upper limit and the lower limit against the obtained reference pixel resolving power, and may decide the upper limit or the lower limit using these ratios. For example, when it sets that a ratio of the lower limit side is 80% and a ratio of the upper limit side is 120%, a range of the pixel resolving power is decided under conditions that 80% of the memorized reference pixel resolving power is the lower limit of the pixel resolving power, and 120% of the memorized reference pixel resolving power is the upper limit of the pixel resolving power. And the display control section 52 judges whether the pixel resolving power is in these calculated limits and controls the display mode.

Note that the ratios of the lower limit and the upper limit described above are not limited to conditions that the lower limit is lower than the memorized reference pixel resolving power, and the upper limit is larger than the memorized reference pixel resolving power. Therefore, it may set for example that the ratio of the lower limit side is 110% and the ratio of the upper limit side is 130%. In addition, it may decide the upper limit and the lower limit by setting a difference (length to be permitted) against the memorized reference pixel resolving power, instead of a ratio against the memorized reference pixel resolving power.

The ratios and differences to decide the upper limit and the lower limit may be input from the operating section 15, and as the ratios and differences, one used at the time of the last photography or one recorded with the reproduced parallax image may be used. In addition, according to selection of each mode such as a high-definition mode which requires high pixel resolving power and a normal mode which requires normal pixel resolving power, one of ratios or differences prepared beforehand may be automatically set. Furthermore, the upper limit and the lower limit may be determined based on a ratio or a difference according to a value of the obtained reference pixel resolving power.

### Fourth Embodiment

A fourth embodiment, in which a range of a photographing condition being set satisfies the reference pixel resolving power and a range that does not satisfy the reference pixel resolving power are displayed, will be described. Note that since it is similar to the third embodiment except for matters to be described below, it refers the same reference number to the substantially same component and omits the detailed description.

By operating the operating section 15, one can be selected from a focal length setting mode for regulating the focal length, a camera interval setting mode for regulating the base length, and a resolution setting mode for changing the resolution.

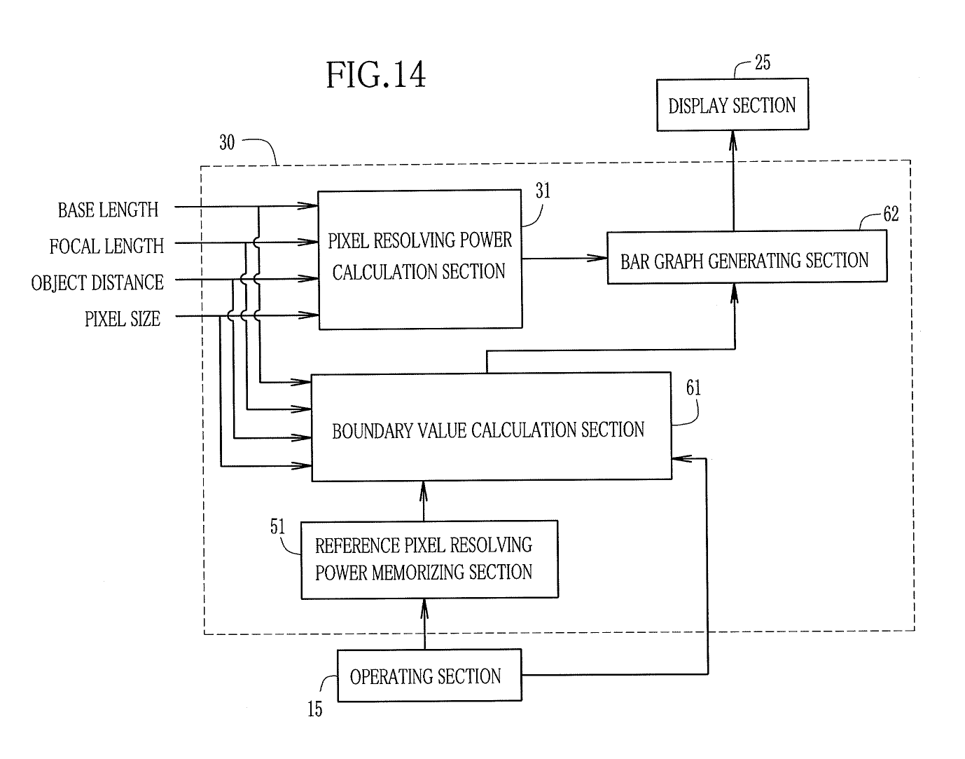

In FIG. 14, about the photographing condition changed in the selected setting mode, a boundary value calculation section 61 of the resolving power display control section 30 in this example calculates a value to implement the reference pixel resolving power memorized in the reference pixel resolving power memorizing section 51, as the boundary value of the photographing condition. In the calculation of the boundary value of this photographing condition, the boundary value is calculated from each current photographing condition other than the relevant photographing condition, and the reference pixel resolving power. For example, when the focal length setting mode is selected, under conditions of the pixel size, the object distance and the base length which are presently set, a focal length to implement the memorized reference pixel resolving power is calculated as the boundary value.

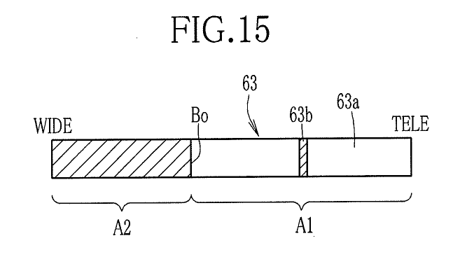

A bar graph generating section 62 generates a bar graph about the photographing condition changed in the selected setting mode and displays it on the display section 25. An example of a bar graph displayed in the focal length setting mode is illustrated in FIG. 15. A belt-shaped bar 63a of a bar graph 63 shows a range of the focal length where zooming of the taking lenses 11a and 12a is possible, in which one end corresponds to a wide-angle end (WIDE end) and the other end corresponds to the telephoto end (TELE end). In the bar 63a, a current value index 63b is displayed. The current value index 63b shows a value of the currently set focal length, and travels in the bar 63a between the wide-angle end and the telephoto end in response to zooming under the focal length setting mode.

The bar 63a described above is divided into an adequate area A1 and an inadequate area A2, from a boundary Bo which is on a position corresponding to the boundary value calculated by the above-described boundary value calculation section 61. The adequate area A1 is an area of focal length where the pixel resolving power that is higher than the memorized reference pixel resolving power can be obtained, and shows a range satisfying the reference pixel resolving power. On the other hand, the inadequate area A2 is an area of focal length where the pixel resolving power becomes lower than the memorized reference pixel resolving power, and shows a range not satisfying the reference pixel resolving power. In the bar graph 63 of this focal length, the telephoto end side from the boundary Bo is considered to be the adequate area A1, and the wide-angle end side from the boundary Bo is considered to be the inadequate area A2. The adequate area A1 and the inadequate area A2 are displayed in each specific colors different with each other, for example, the adequate area is white or transparent, and the inadequate area is red, so as to be able to be easily distinguished.

About the focal length being set, a range satisfying the reference pixel resolving power and a range not to satisfy can be easily found through referring to the bar graph 63, and the relations with the current focal length can be found from them and the current value index 63b.

In the camera interval setting mode, a similar bar graph about the base length is displayed. In the resolution setting mode, the boundary value of the pixel size is obtained, and a similar bar graph of the pixel size is displayed. Note that the graph may be displayed about the resolution obtained by converting the pixel size. In addition, when a mode is selected for example from a high-resolution mode which is high in resolution, a standard-resolution mode which is standard in resolution and a low-resolution mode which is low in resolution, a position of the each mode may be represented in the bar graph so that the relation with the boundary value can be recognized.

The object distance in the photographing condition may be displayed like other photographing conditions, in case that the shifting mechanism is provided for relatively shifting the measurement object Obj against the each camera 11, 12 to obtain the object distance designated through the operating section 15, or that the object distance of the measurement object Obj is input through the operating section 15, as described above.

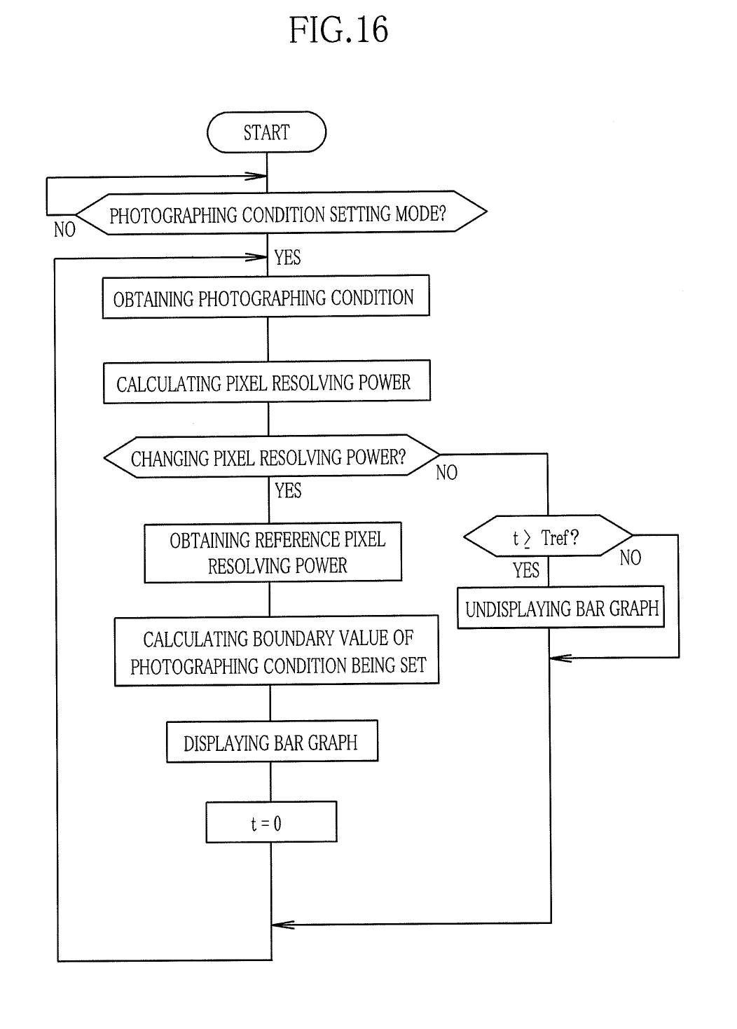

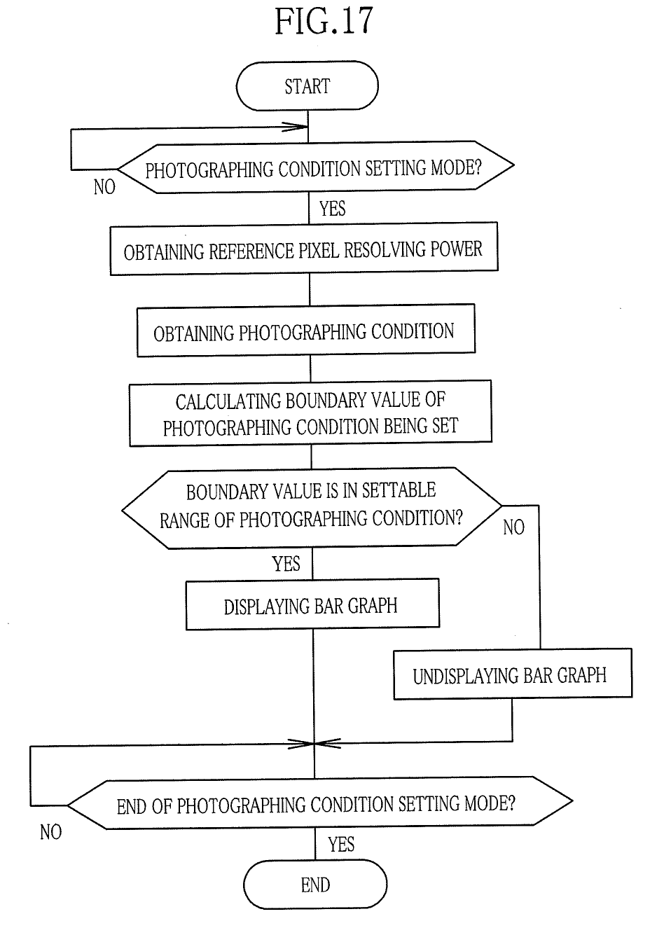

In the above example, the bar graph of the photographing condition being set in the setting mode is always displayed under the setting mode, however, for example a bar graph may be displayed during a constant period in response to a change of pixel resolving power as illustrated in FIG. 16. Of course, a bar graph may be displayed during a constant period in response to a change of photographing condition. In addition, as illustrated in FIG. 17, a bar graph may be displayed only when the boundary value of the calculated photographing condition is in the range that can be set in the concerned photographing condition.

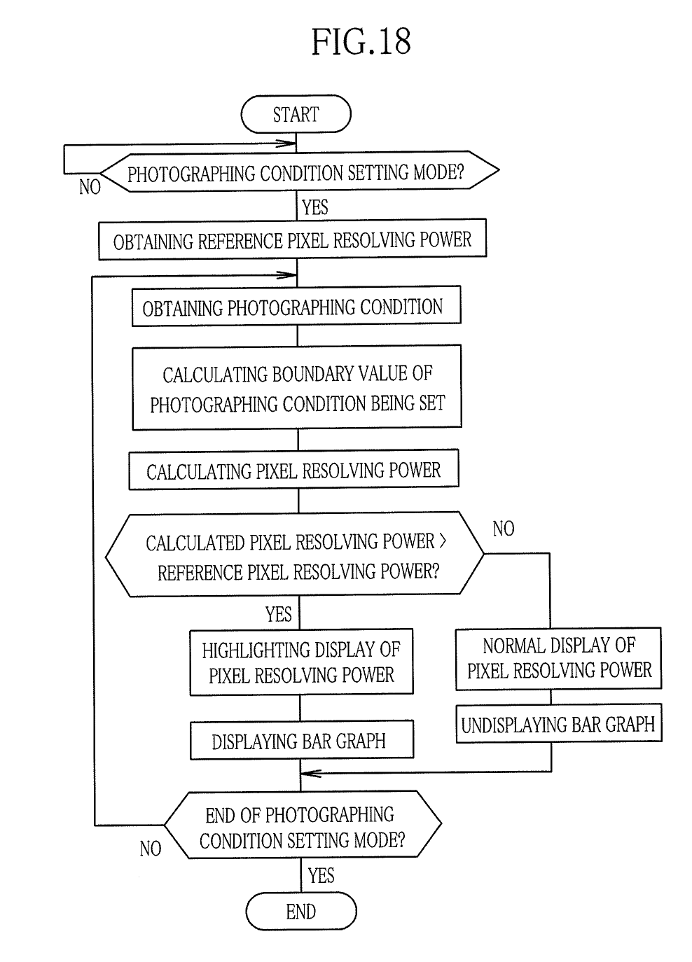

In an example illustrated in FIG. 18, under the setting mode, the pixel resolving power calculated from the each photographing condition and the upper limit of the reference range (the reference pixel resolving power) are compared with each other between the corresponding ones like the third embodiment, and then the each pixel resolving power is subject to the highlighting display when the latter is larger than the former (the pixel resolving power is low). The bar graph 63 is additionally displayed, but when the latter is as same as or smaller (the pixel resolving power is higher) than the former, the normal display is applied to the each pixel resolving power, and the bar graph 63 becomes undisplayed. When the bar graph 63 is displayed in this example, the current value index 63b will be displayed in the inadequate area A2. In addition, in case display of the bar graph 63 is controlled, the reference range may be defined by the upper limit and the lower limit.

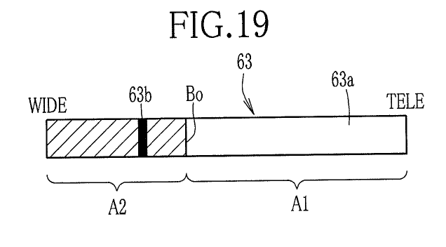

In this case, as an example illustrated in FIG. 19, the each end sides (the telephoto end side and the wide-angle end side) of the bar 63a are the inadequate area A2, and the area between them is the adequate area A1. Note that it may be a constitution which controls only the display of the bar graph, without changing display mode of the pixel resolving power.

Although the current value of the photographing condition being set is displayed in the each example in the fourth embodiment described above, it may be a constitution that does not display the current value. In addition, it may warn or prohibit photography when the current value is in the inadequate area A2, that is, when a photographing condition is set to make the pixel resolving power be lower than the reference pixel resolving power, and it is also preferable to prohibit setting of the photographing condition which makes the pixel resolving power be lower than the reference pixel resolving power.

In addition, display of the satisfying range and the unsatisfying range is not limited to the bar graph, but it should be easily recognized as a graphical display. Furthermore, it may change the color only for the position of the boundary value in the bar graph, display the boundary value with a numerical value, and display the difference between the current value and the boundary value. These can be used in combination with the other embodiments described above.

In the first to fourth embodiments, the example in which the optical axes PL1, PL2 of the cameras 11, 12 are parallel to each other is described, however it may be that the cameras 11, 12 are not parallel to each other and arranged with a suitable angle of convergence, and the pixel resolving power is calculated in consideration of the angle of convergence.

### Fifth Embodiment

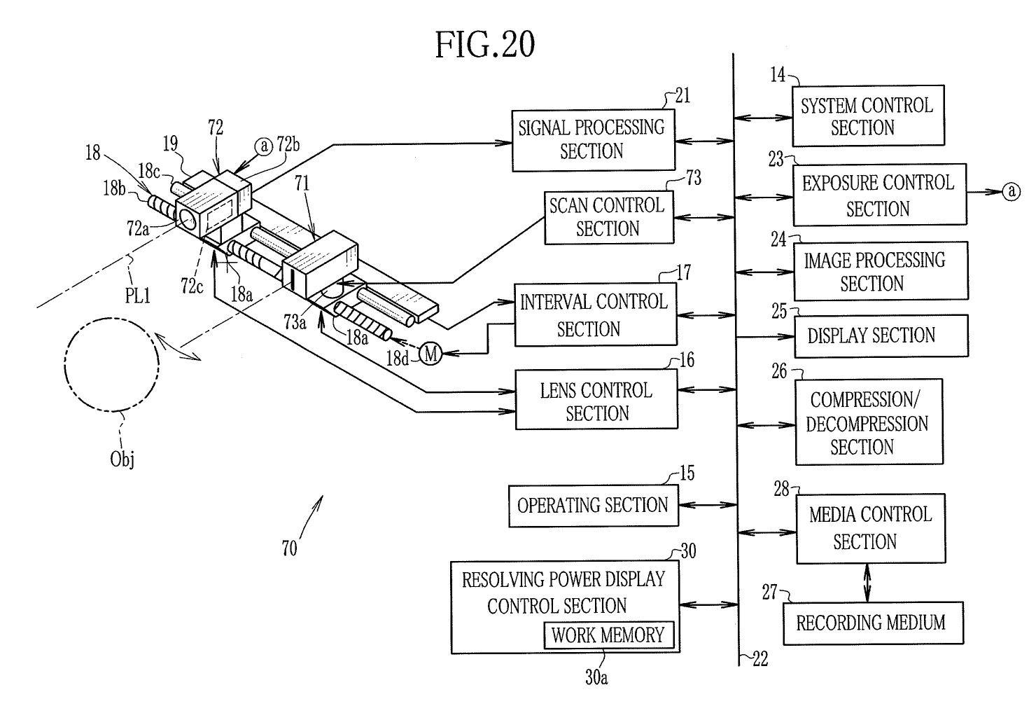

A constitution of a photographing device in a fifth embodiment is illustrated in FIG. 20. This photographing device 70 photographs a measurement image to measure three-dimensional information of the measurement object by light-section method. Note that since it is similar to the first embodiment except that the photographing device 70 irradiates the measurement object with slit-light and photographs the measurement image with one camera, it refers the same reference number to the substantially same component and omits the detailed description.

On the shifting member18a, a projector 71 and a camera 72 is disposed. The projector 71 irradiates the measurement object Obj with slit-light of a lengthwise-slit shape which is output, for example, from a laser device while the photography mode. This projector 71 has a scanner 73a whose drive is controlled by a scan control section 73, and repeatedly performs shifting of the irradiation position for slit-light and irradiation of slit-light from the scanner 73a.

The camera 72 is composed of a taking lens 72a and an image sensor section 72b, and photographs the measurement image. In the photography mode, while an irradiation position of slit-light sequentially travels a range photographed as the measurement image, a large number of slit-lights whose irradiation positions are varied are photographed as one piece of measurement image, by performing charge-storage in the image sensor section 72b. By analyzing the measurement image photographed as described above, three-dimensional information of the measurement object Obj is calculated. Note that it may photograph one piece of measurement image whenever the irradiation position of slit-light moves.

Also in this example, it may perform the display of the pixel resolving power and the display of the satisfying range and the unsatisfying range, like the first to fourth embodiments described above, with consideration of photographing conditions such as the focal length of the camera 72, the object distance to the measurement object Obj, the pixel size of the measurement image and the base length which is the interval between the projector 71 and the camera 72.

Although the three-dimensional information device using light-section method is described in the fifth embodiment, the present invention is not limited to this, and may be applied to various three-dimensional information devices that irradiates a measurement object with light from a projector, and photographs this image as a measurement image. For example, it may be applied to a constitution in which a lattice pattern is projected to a measurement object from a projector and a distorted lattice image in the work is photographed with a camera as a measurement image, and a constitution in which spot light irradiated to a measurement object from a projector is captured by a camera as a measurement image.

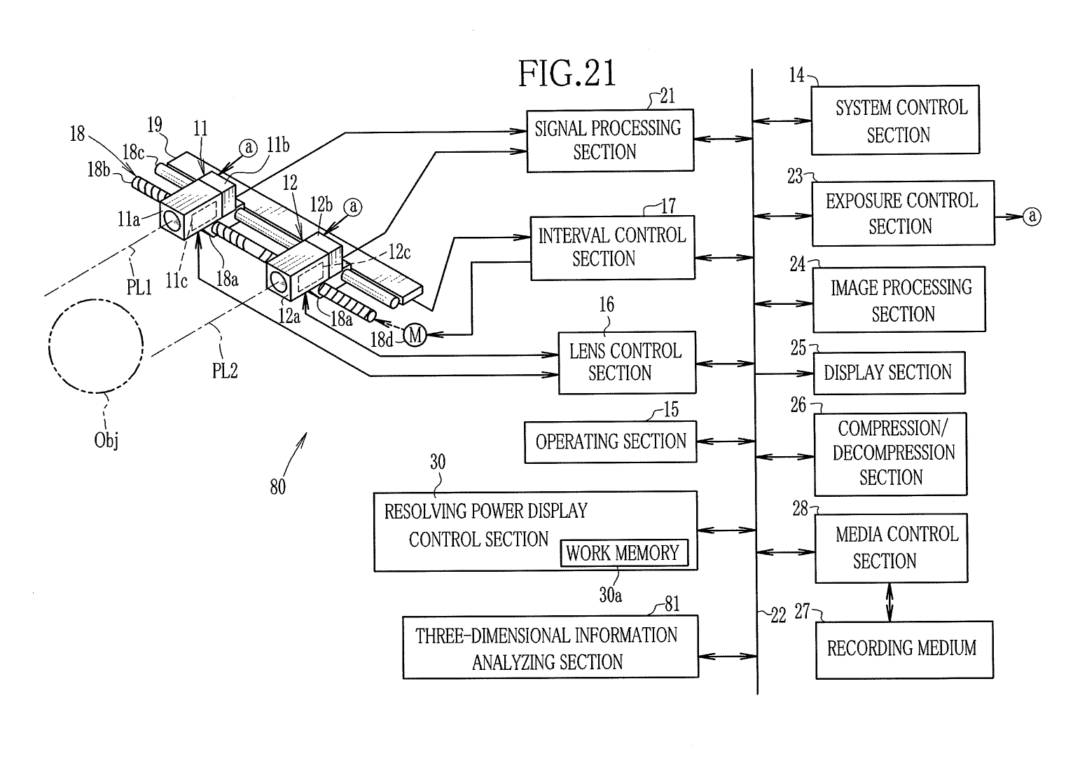

In the above embodiments, the photographing devices that photograph the measurement image are described, however, it may be a three-dimensional information obtaining device including the photographing device. For example, FIG. 21 illustrates an example of a three-dimensional information obtaining device 80 in which the photographing device 10 is provided with a three-dimensional information analyzing section 81 for analyzing a parallax image. The three-dimensional information analyzing section 81 analyzes the parallax image and obtains three-dimensional information by calculation. In this analysis, the parallax of correspondence points in perspective images is obtained, so as to calculate the distance in the direction parallel to the optical axis of the taking lens (the distance in the depth direction) and coordinates in the plane direction that is perpendicular to the depth direction, based on this parallax, a pixel size of the each camera 11, 12, a focal length, an object distance and a camera interval (base length). The calculated three-dimensional information is displayed in the display section 25 and recorded in the recording medium 27.

In addition, a computer may be connected to a camera that photographs plural perspective images, and may be connected to a device including a camera and a projector, as a constitution of the each embodiment described above.

1-19. (canceled)

20. A photographing device comprising:
a measurement photography section for photographing a measurement image of a measurement object to obtain three-dimensional information;
a condition obtaining section for obtaining a photographing condition for photographing the measurement image;
a pixel resolving power calculation section for calculating pixel resolving power based on the photographing condition;
a display section for displaying the pixel resolving power that is calculated in the pixel resolving power calculation section;
a reference pixel resolving power obtaining section for obtaining reference pixel resolving power for photographing the measurement image;
a display control section for changing a display mode of the display section when it is detected that the pixel resolving power becomes out of a reference range determined based on the reference pixel resolving power;
a recording section for recording the pixel resolving power or the photographing condition with the measurement image when the measurement image is photographed; and
a selecting section for selecting any measurement image from a plurality of the measurement images,
wherein the reference pixel resolving power obtaining section obtains pixel resolving power or photographing condition corresponding to the selected measurement image, and determines this pixel resolving power or pixel resolving power obtained from the photographing condition as the reference pixel resolving power.

21. The photographing device according to claim 20, wherein the display section reproduces and displays the measurement image selected by the selecting section.

22. The photographing device according to claim 20, further comprising a photographing condition range display section to display a condition range of the photographing condition for making the pixel resolving power, which is calculated in the pixel resolving power calculation section, become in the reference range when the calculated pixel resolving power is out of the reference range at the time of setting the photographing condition.

23. The photographing device according to claim 22, wherein the photographing condition range display section displays a range out of the photographing condition range separately from the photographing condition range, in addition to the photographing condition range.

24. The photographing device according to claim 20, wherein
the measurement photography section has plural cameras to photograph each perspective image as the measurement image, and
the condition obtaining section obtains a focal length, an object distance, a pixel size, and a base length that is a distance between the cameras as the photographing condition.

25. The photographing device according to claim 20, further comprising a projector section for projecting measuring beam on the measurement object,
wherein the measurement photography section photographs the measurement object being irradiated by the measuring beam.

26. A three-dimensional information measuring device comprising:
a photographing device including:
a measurement photography section for photographing a measurement image of a measurement object to obtain three-dimensional information;
a condition obtaining section for obtaining a photographing condition for photographing the measurement image;
a pixel resolving power calculation section for calculating pixel resolving power based on the photographing condition;
a display section for displaying the pixel resolving power that is calculated in the pixel resolving power calculation section;
a reference pixel resolving power obtaining section for obtaining reference pixel resolving power for photographing the measurement image;
a display control section for changing a display mode of the display section when it is detected that the pixel resolving power becomes out of a reference range determined based on the reference pixel resolving power;
a recording section for recording the pixel resolving power or the photographing condition with the measurement image when the measurement image is photographed; and
a selecting section for selecting any measurement image from a plurality of the measurement images,
wherein the reference pixel resolving power obtaining section obtains pixel resolving power or photographing condition corresponding to the selected measurement image, and determines this pixel resolving power or pixel resolving power obtained from the photographing condition as the reference pixel resolving power; and
an analyzing section for calculating the three-dimensional information based on the measurement image photographed by the photographing device.

27. A controlling method of a photographing device, which photographs a measurement image of a measurement object for obtaining three-dimensional information, comprising:
a calculation step for calculating pixel resolving power from a photographing condition of the measurement image;
a displaying step for displaying the pixel resolving power on a display section;
an obtaining step for obtaining reference pixel resolving power in photographing the measurement image;
a judgment step for judging whether the pixel resolving power becomes out of the reference range determined based on the reference pixel resolving power;
a changing step for changing display mode of the pixel resolving power on the display section when the pixel resolving power becomes out of the reference range;
a recording step for recording the pixel resolving power or the photographing condition with the measurement image when the measurement image is photographed; and
a selection step for selecting any measurement image from a plurality of measurement images,
wherein the pixel resolving power or the photographing condition of the selected measurement image is obtained, and this pixel resolving power or pixel resolving power obtained from the photographing condition is determined as the reference pixel resolving power in the obtaining step.

28. The controlling method of a photographing device according to claim 27, wherein the selected measurement image is reproduced and displayed on the display section.

29. The controlling method of a photographing device according to claim 27, further comprising:
a setting step for setting at least one of the plural photographing conditions; and
a range displaying step for displaying a condition range of the photographing condition for making the pixel resolving power, which is calculated in the calculation step, become in the reference range when the pixel resolving power is out of the reference range.

30. The controlling method of a photographing device according to claim 29, wherein a range out of the photographing condition range is displayed separately from the photographing condition range in addition to the photographing condition range on the display section in the range displaying step.

31. The controlling method of a photographing device according to claim 27, further comprising a photographing step for photographing plural perspective images from different viewpoints as the measurement image with use of plural cameras.

32. The controlling method of a photographing device according to claim 27, further comprising a photographing step for photographing the measurement object irradiated by measurement light.

33. The photographing device according to claim 20, wherein the display section displays a through image of the measurement image with the pixel resolving power that is calculated in the pixel resolving power calculation section.

34. The controlling method of a photographing device according to claim 27, wherein a through image of the measurement image is displayed with the pixel resolving power that is calculated in the calculation step.

35. The photographing device according to claim 20, wherein:
the selecting section selects the measurement image, at the time of photographing a next measurement image, from the plurality of the measurement images which is recorded by the recording section, and
the reference pixel resolving power obtaining section determines the pixel resolving power corresponding to the selected measurement image or the pixel resolving power obtained from the photographing condition as the reference pixel resolving power for photographing the next measurement image.

36. The three-dimensional information measuring device according to claim 26, wherein:
the selecting section selects the measurement image, at the time of photographing a next measurement image, from the plurality of the measurement images which is recorded by the recording section, and
the reference pixel resolving power obtaining section determines the pixel resolving power corresponding to the selected measurement image or the pixel resolving power obtained from the photographing condition as the reference pixel resolving power for photographing the next measurement image.

37. The controlling method according to claim 27, wherein:
the selection step comprises selecting the measurement image, at the time of photographing a next measurement image, from the plurality of the measurement images which is recorded in the recording step, and
the pixel resolving power of the selected measurement image or the pixel resolving power obtained from the photographing condition is determined as the reference pixel resolving power for photographing the next measurement image, in the obtaining step.
